(19) United States
(12) Patent Application Publication
(10) Pub. No.: US 2021/0072359 A1
(43) Pub. Date: Mar. 11, 2021

(54) PHOTO DETECTION DEVICE, ELECTRONIC DEVICE, AND PHOTO DETECTION METHOD

(71) Applicant: KABUSHIKI KAISHA TOSHIBA, Minato-ku (JP)

(72) Inventors: Tuan Thanh TA, Kawasaki (JP); Akihide SAI, Yokohama (JP); Hidenori OKUNI, Yokohama (JP); Toshiki SUGIMOTO, Yokohama (JP)

(73) Assignee: KABUSHIKI KAISHA TOSHIBA, Minato-ku (JP)

(21) Appl. No.: 16/812,488

(22) Filed: Mar. 9, 2020

(30) Foreign Application Priority Data
Sep. 5, 2019 (JP) 2019-162247

(51) Int. Cl. G01S 7/4863; G01S 7/481; G01S 17/10

(52) U.S. Cl. CPC G01S 7/4863; G01S 17/10; G01S 7/4817; G01S 7/4816

(57) ABSTRACT

A photo detection apparatus has an array of light detectors that can be switched to an ON state to enable output of a signal based on reception light or an OFF state to disable output of the signal based on reception light, and control circuitry configured to set one or more first light detectors inside a region specified according to overlapping of a region irradiated with light from a first direction and a region capable of detecting light to the ON state among the array of light detectors, when the light from the first direction is received by the array and set second light detectors outside of the specified region to the OFF state among the array of light detectors, when light from a first direction is received by the array.

### CROSS REFERENCE TO RELATED APPLICATIONS

This application is based upon and claims the benefit of priority from the prior Japanese Patent Application No. 2019-162247, filed on Sep. 5, 2019, the entire contents of which are incorporated herein by reference.

### FIELD

Embodiments described herein relate generally to a photo detection device, an electronic device, and a photo detection method.

### BACKGROUND

Photo detection devices such as light receiving elements are widely used in automatic driving technology and the like. In the automatic driving technology, reflected light from an object is received by a photo detection device, a distance to the object is measured, and a distance image is generated. To increase the resolution of the distance image, it is necessary to increase the number of light receiving elements per unit area included in the photo detection device. However, when the distance between the light receiving elements is shortened, crosstalk occurs between the light receiving elements, causing blurring of the distance image and noises.

Further, as the number of light receiving elements in the photo detection device increases, it becomes difficult to secure a place for arranging the output wire of each light receiving element. In addition, there is a limit to the total number of light receiving elements that can be placed because of a need to secure a place for arranging the output wire.

### BRIEF DESCRIPTION OF THE DRAWINGS

FIG. 1 is a block diagram illustrating a schematic configuration of an electronic device having a photo detection device built therein according to an embodiment;

FIG. 2 is a block diagram illustrating an internal configuration of a light receiving sensor that functions as the photo detection device according to the embodiment;

FIG. 3 is a diagram schematically illustrating desired reflected light incident on the light receiving array;

FIGS. 4A, 4B, and 4C are diagrams for describing a reason why a position and a diameter of the beam spot of the reflected light do not change depending on the distance from an object to the light receiving array;

FIG. 5 is a diagram illustrating an example of dynamically controlling a light receiving element that is turned on by a control unit;

FIG. 6 is a block diagram illustrating an inner configuration of a photo detection device 1 according to a second embodiment;

FIG. 7 is a diagram illustrating an example in which every fourth light receiving element among a plurality of light receiving elements arranged in a first direction is connected to the same output wire; and

FIG. 8 is a schematic perspective view illustrating an example in which a light receiving unit and a signal processing unit are mounted on a semiconductor substrate.

### DETAILED DESCRIPTION

A photo detection device according to one embodiment has an array of light detectors that can be switched to an ON state to enable output of a signal based on reception light or an OFF state to disable output of the signal based on reception light, and control circuitry configured to set one or more first light detectors inside a region specified according to overlapping of a region irradiated with light from a first direction and a region capable of detecting light to the ON state among the array of light detectors, when the light from the first direction is received by the array; and set second light detectors outside of the specified region to the OFF state among the array of light detectors, when light from a first direction is received by the array.

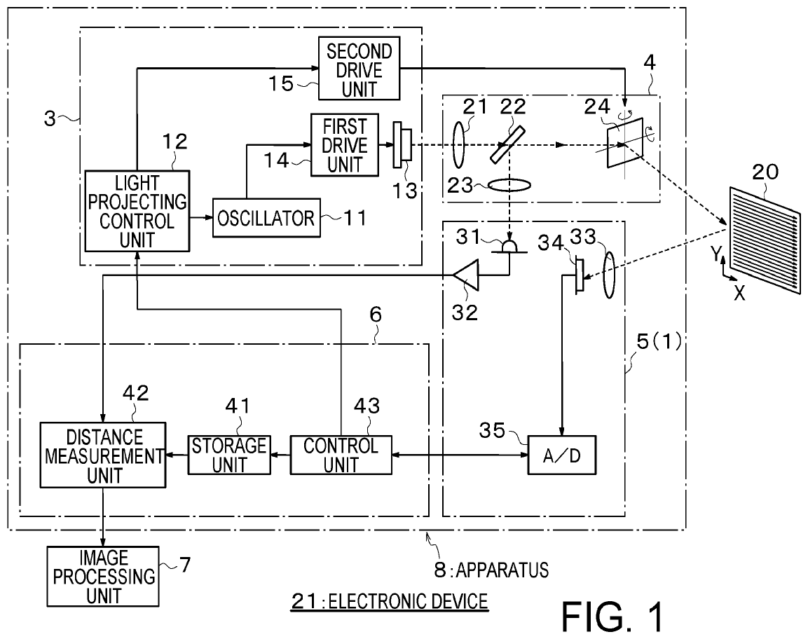

FIG. 1 is a block diagram illustrating a schematic configuration of an electronic apparatus 2 that has a photo detection apparatus 1 built therein according to an embodiment. The electronic apparatus 2 of FIG. 1 performs distance measurement by a ToF (Time of Flight) method. The electronic apparatus 2 of FIG. 1 includes a light projecting unit (light projector) 3, a light control unit 4, a light receiving unit 5, a signal processing unit 6, and an image processing unit 7. Among these, the light projecting unit 3, the light control unit 4, the light receiving unit 5, and the signal processing unit 6 form a distance measuring apparatus 8. The photo detection apparatus 1 according to this embodiment is mounted as at least a part of the light receiving unit 5.

At least a part of the electronic apparatus 2 of FIG. 1 can be configured by one or more semiconductor Integrated Circuits (ICs). For example, the signal processing unit 6 and the image processing unit 7 may be integrated inside one semiconductor chip, or the light receiving unit 5 may also be integrated on this semiconductor chip. Further, the light projecting unit 3 may also be integrated on this semiconductor chip.

The light projecting unit 3 projects the first light. The first light is, for example, a laser light in a predetermined frequency band. The laser light is a coherent light having the same phase and frequency. The light projecting unit 3 intermittently projects the pulsed first light at a predetermined period. The period in which the light projecting unit 3 projects the first light is a time interval that is equal to or more than a time required to measure a distance by the distance measuring apparatus 8 based on one pulse of the first light.

The light projecting unit 3 includes an oscillator 11, a light projecting control unit 12, a light source 13, a first drive unit 14, and a second drive unit 15. The oscillator 11 generates an oscillation signal corresponding to the cycle of projecting the first light. The first drive unit 14 intermittently supplies power to the light source 13 in synchronization with the oscillation signal. The light source 13 intermittently emits the first light based on the power from the first drive unit 14. The light source 13 may be a laser element that emits a single laser light or a laser unit that emits a plurality of laser light simultaneously. The light projecting control unit 12 controls the second drive unit 15 in synchronization with the oscillation signal. The second drive unit 15 supplies a drive signal synchronized with the oscillation signal to the light control unit 4 in response to an instruction from the light projecting control unit 12.

The light control unit 4 controls a traveling direction of the first light emitted from the light source 13. In addition, the light control unit 4 controls the traveling direction of the received second light.

The light control unit 4 includes a first lens 21, a beam splitter 22, a second lens 23, and a scanning mirror 24.

The first lens 21 condenses the first light emitted from the light projecting unit 3 and guides the light to the beam splitter 22. The beam splitter 22 branches the first light from the first lens 21 in two directions and guides the light to the second lens 23 and the scanning mirror 24. The second lens 23 guides the branched light from the beam splitter 22 to the light receiving unit 5. The reason for guiding the first light to the light receiving unit 5 is to detect a light projection timing in the light receiving unit 5.

The scanning mirror 24 rotates and drives a mirror surface in synchronization with the drive signal from the second drive unit 15 in the light projecting unit 3. With this configuration, the reflection direction of the branched light (first light) that has passed through the beam splitter 22 and entered the mirror surface of the scanning mirror 24 is controlled. By rotating and driving the mirror surface of the scanning mirror 24 at a constant cycle, scanning can be performed by the first light emitted from the light control unit 4 in at least a one-dimensional direction within a predetermined range. By providing the axis for rotationally driving the mirror surface in two directions, scanning can be performed by the first light emitted from the light control unit 4 in a two-dimensional direction within a predetermined range. FIG. 1 illustrates an example in which the scanning mirror 24 performs scanning by the first light projected from the electronic apparatus 2 in an X direction and a Y direction.

In a case where the object 20 exists within a scanning range of the first light projected from the electronic apparatus 2, the first light is reflected by the object 20. At least part of the reflected light reflected by the object 20 is received by the light receiving unit 5.

The light receiving unit 5 includes a photodetector 31, an amplifier 32, a third lens 33, a light receiving sensor 34, and an A/D converter 35. The photodetector 31 receives the light branched by the beam splitter 22 and converts it into an electrical signal. The photodetector 31 can detect the light projection timing of the first light. The amplifier 32 amplifies the electrical signal output from the photodetector 31.

The third lens 33 focuses the laser light reflected by the object 20 on the light receiving sensor 34. The light receiving sensor 34 is the photo detection apparatus 1 according to this embodiment, and details thereof will be described below. The light receiving sensor 34 receives the laser light and converts the light into an electrical signal.

The A/D converter 35 samples the electrical signal output from the light receiving sensor 34 at a predetermined sampling rate, performs A/D conversion, and generates a digital signal. Instead of the A/D converter 35, a time digital converter (TDC) can be used.

The signal processing unit 6 includes a storage unit 41, a distance measurement unit (processor) 42, and a control unit 43. The signal processing unit 6 measures a distance to the object 20 that reflects the first light, and stores a digital signal corresponding to the second light received by the light receiving sensor 34 in the storage unit 41.

The distance measurement unit 42 measures the distance to the object 20 based on the first light and the reflected light from the object 20. More specifically, the distance measurement unit 42 measures the distance to the object 20 on the basis of a time difference between the light projection timing of the first light and the light reception timing of the reflected light included in the second light received by the light receiving sensor 34. In other words, the distance measurement unit 42 measures the distance to the object 20 on the basis of the following Expression (1).

Distance=Light Speed×(Light Reception Timing of Reflected Light−Light Projection Timing of First Light)/2 (1)

The “Light Reception Timing of Reflected Light” in Expression (1) is more accurately a light reception timing of a peak position of the reflected light. The distance measurement unit 42 detects the peak position of the reflected light included in the second light on the basis of the digital signal generated by the A/D converter 35.

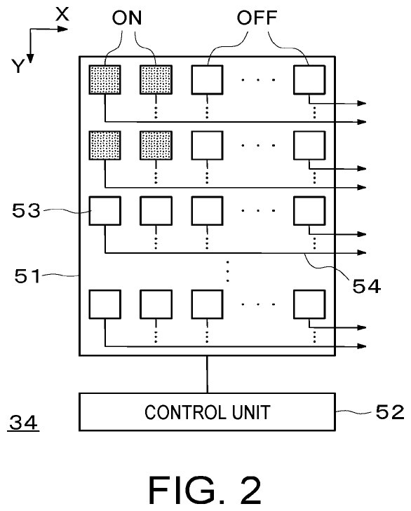

FIG. 2 is a block diagram illustrating an internal configuration of the light receiving sensor 34 that functions as the photo detection apparatus 1 according to this embodiment. The light receiving sensor 34 of FIG. 2 includes a light receiving array 51 and a control unit (control circuitry) 52. Hereinafter, the light receiving array 51 may be simply called as the array 51.

The light receiving array 51 includes a plurality of light receiving elements (light detectors) 53 that can be individually switched to an ON state in which light is received or an OFF state in which light is not received. In the example of FIG. 2, the plurality of light receiving elements 53 are arranged in a two-dimensional direction (second direction X and third direction Y), but may be arranged only in a one-dimensional direction (second direction X). An output wire 54 that transfers the electrical signal photoelectrically converted when light is received by each light receiving element 53 is connected to each of the plurality of light receiving elements 53. The output wires 54 are arranged in the gaps between the light receiving elements 53 in the third direction Y.

In this embodiment, a Silicon Photon Avalanche Diode (SPAD) is used as the light receiving element 53. The SPAD is an Avalanche Photo-Diode (APD) operated in a Geiger mode, and can output an electrical signal by receiving a single photon. In the example of FIG. 2, the plurality of light receiving elements 53 are arranged in the second direction X (horizontal direction) and the third direction Y (vertical direction). Further, in an actual light receiving array 51, the plurality of light receiving elements 53 form one pixel, and a plurality of pixels are often arranged in the vertical and horizontal directions. The unit of one pixel is also called a Silicon Photomultiplier (SiPM). FIG. 2 illustrates a simplified configuration of the light receiving array 51, and illustrates an example in which the plurality of light receiving elements 53 are arranged in the vertical and horizontal directions.

When light is incident on a SPAD with a reverse bias voltage exceeding a breakdown voltage, an avalanche current is generated, and a large current is output. At that time, light is emitted from a place where the avalanche current is generated. There is a concern that other light receiving elements 53 in the vicinity sense this light and output an electrical signal by photoelectric conversion. This electrical signal is a noise, and also called crosstalk.

In a case where the control unit 52 receives light from a first direction by the light receiving array, the control unit controls such that one or more light receiving elements 53 which are determined as those that the region irradiated with light from the first direction and the region capable of receiving light are at least partially overlapped, among the plurality of light receiving elements 53, are set to the ON state, and the other light receiving elements 53 are set to the OFF state. That is, the control unit 52 set one or more first light receiving elements 53 inside a region specified according to overlapping of a region irradiated with light from a first direction and a region capable of detecting light to the ON state among the array of light receiving elements 53, when the light from the first direction is received by the array, and set second light detectors outside of the specified region to the OFF state among the array of light receiving elements 53, when light from a first direction is received by the array. FIG. 2 illustrates an example in which the hatched light receiving element 53 is turned on and the white light receiving element 53 is turned off.

In this manner, the control unit 52 turns on only some of the light receiving elements 53 and acquires the electrical signal received by the turned-on light receiving elements 53 via the output wire 54. Here, the light from the first direction is the light that is obtained when the projected light is reflected by the object 20. The first direction is a direction in which the reflected light obtained when the projected light is reflected by the object 20 arrives. The control unit 52 controls one or more light receiving elements 53 that are determined as those that the region irradiated with the reflected light from the first direction and the region capable of receiving light are at least partially overlapped to be turned on. More specifically, the control unit 52 controls one or more light receiving elements 53 to be the ON state among the plurality of light receiving elements 53 on the basis of the light receiving position and the beam spot diameter of the light from the first direction on the light receiving surface of the light receiving array 51.

The light control unit 4 performs scanning by the light projected by the light projecting unit 3. Therefore, the direction of light changes with time, and the direction reflected by the object 20 also changes according to a scanning direction of light. The control unit 52 dynamically controls one or more light receiving elements 53 to be turned on among the plurality of light receiving elements 53 in accordance with the direction (first direction) of reflected light from the object 20.

In the light receiving array 51, the light projected from the light projecting unit 3 is reflected by the object 20, and not only the reflected light but also ambient light such as sunlight is incident. In addition, the ambient light may be reflected by the object 20 and the reflected light may enter the light receiving array 51. Among these lights, the light used for distance measurement is the light that is projected from the light projecting unit 3 and reflected by the object 20 and is incident on the light receiving array 51. In the following, the light will be referred to as a desired reflected light. The desired reflected light is projected from the light projecting unit 3, travels according to the direction of the light used for scanning by the light control unit 4, is reflected by the object 20, and enters a specific position on the light receiving array 51.

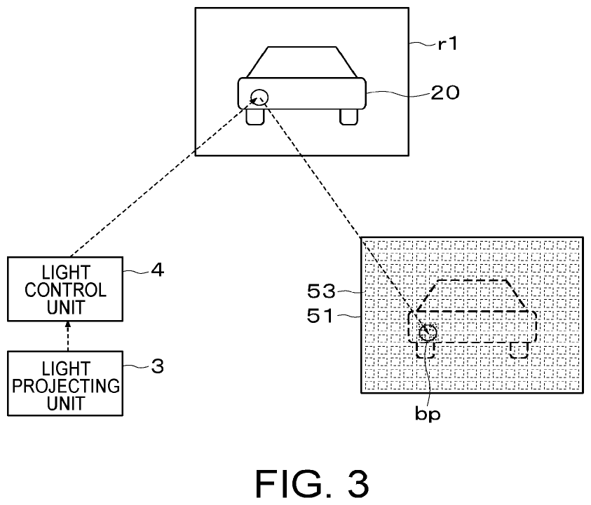

FIG. 3 is a diagram schematically illustrating the desired reflected light incident on the light receiving array 51. The light control unit 4 performs scanning by the light from the light projecting unit 3 within a predetermined range r1. Among the lights used for scanning by the light control unit 4, the light reflected by the object 20 is the desired reflected light. The desired reflected light is incident on a predicted position in the light receiving array 51. Here, the predicted position is a direction corresponding to the direction of light used for scanning by the light control unit 4. In other words, the incident position of the desired reflected light in the light receiving array 51 can be specified by the direction of the light used for scanning by the light control unit 4. Therefore, the control unit 52 turns on the light receiving elements 53 in the light receiving array 51 in which the desired reflected light may be incident according to the direction of the light used for scanning by the light control unit 4.

In FIG. 3, a distance image of the object 20 obtained when light (for example, the ambient light such as sunlight) other than the desired reflected light is reflected by the object 20 and is incident on the light receiving array 51 is indicated by a broken line. A solid line circle bp indicates a beam spot in a case where the desired reflected light is incident on the light receiving array 51. In a case where the light projecting unit 3 projects a laser light, the beam spot bp of the laser light is very small compared to an LED light or the like. However, since the beam spot has a certain area, the control unit 52 determines the light receiving element 53 to be turned on in consideration of the diameter of the beam spot bp of the desired reflected light. More specifically, only the light receiving element 53 in which an overlap ratio obtained by normalizing the area of the beam spot bp of the desired reflected light on the light receiving element 53 by the area of the light receiving element 53 exceeds a predetermined value (for example, 10%) is turned on. Alternatively, only the light receiving element 53 that is completely included in the beam spot bp of the desired reflected light may be turned on.

The light projecting unit 3 intermittently projects light, and the light control unit 4 continuously performs scanning by the light projected by the light projecting unit 3 within a predetermined range. Therefore, the direction of the light emitted from the light control unit 4 continuously changes, and the direction of the desired reflected light reflected by the object 20 also changes continuously. The control unit 52 switches the light receiving element 53 to be turned on by following a continuous change in the desired reflected light.

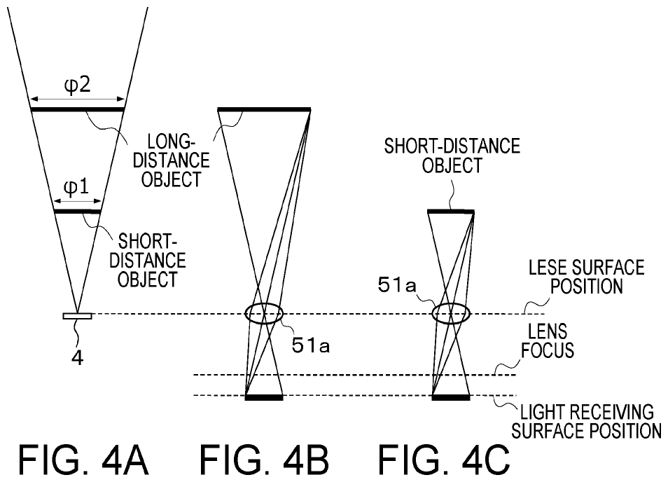

The light projected from the light projecting unit 3 and used for scanning by the light control unit 4 is reflected by the object 20. However, the time until the desired light reflected on the object 20 reaches the light receiving array 51 changes depending on the distance from the light projecting unit 3 to the object 20. However, the position and the diameter of the beam spot bp of the desired reflected light on the light receiving array 51 hardly depend on the distance from the object 20 to the light receiving array 51. FIG. 4 is a diagram for describing the reason why the position and the diameter of the reflected light beam spot bp do not change depending on the distance from the object 20 to the light receiving array 51. As illustrated in FIG. 4A, even if the light projected by the light projecting unit 3 and used for scanning by the light control unit 4 is a laser light, the beam spot diameter is widened depending on a propagation distance. In FIG. 4A, the beam spot diameter of the laser light incident on the object 20 at a short distance is φ1, and the beam spot diameter of the laser light incident on the object 20 at a long distance is φ2.

On the other hand, FIG. 4B illustrates an optical path until the reflected light from the object 20 at a long distance enters the light receiving array 51. FIG. 4C illustrates a light path until the reflected light from the object 20 at a short distance enters the light receiving array 51. The reflected light from the object 20 is collected by a lens 51a provided in the vicinity of the light receiving array 51, and imaged on the light receiving surface of the light receiving array 51. The diameter of the lens 51a is about 1 to 2 cm. The distance from the light receiving array 51 to the object 20 is 10 to 200 m, which is much larger than the diameter of the lens 51a.

As can be seen by comparing FIG. 4B and 4C, the laser spot on the light receiving surface of the light receiving array 51 has a slight blur, so the beam spot diameter varies slightly depending on the distance to the object 20. However, since the size of the lens 51a is much smaller than the distance from the light receiving array 51 to the object 20, the amount of blurring on the light receiving surface of the light receiving array 51 is small, and the change in the beam position is small.

Therefore, the control unit 52 does not necessarily consider the distance from the light receiving array 51 to the object 20 when setting the light receiving element 53 to be turned on. However, since the beam position on the light receiving surface may be slightly shifted depending on the distance to the object 20, the control unit 52 may set the light receiving element 53 to be turned on when the light is projected by the light projecting unit 3 using the result of measuring the distance to the object 20. For example, the light receiving element 53 to be turned on may be shifted in at least one of the second direction X and the third direction Y in a case where the object 20 is at a short distance or at a long distance. The shift amount may be changed according to the distance to the object 20, or it may be set whether the object 20 is shifted by a predetermined amount by two options of a short distance or a long distance.

The light control unit 4 performs scanning by the light from the light projecting unit 3 in a one-dimensional direction or a two-dimensional direction. The control unit 52 may dynamically control the light receiving element 53 to be turned on based on the scanning direction and the scanning speed of the light by the light control unit 4.

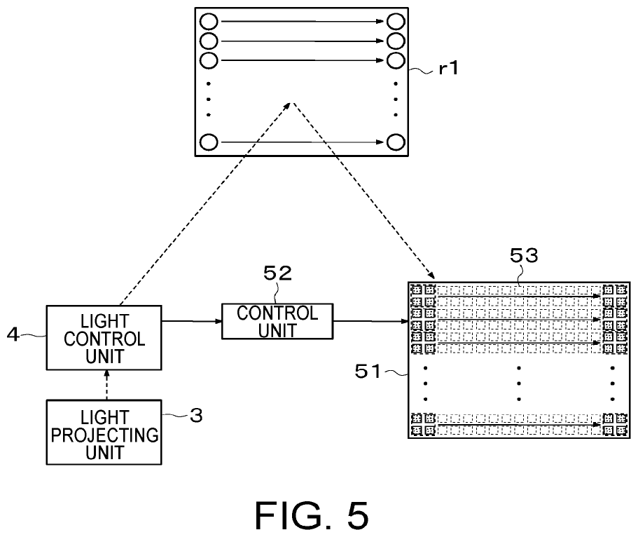

FIG. 5 is a diagram illustrating an example in which the control unit 52 dynamically controls the light receiving element 53 to be turned on. The control unit 52 acquires information on the direction and the speed at which the light control unit 4 scans the light from the light projecting unit 3 from the light control unit 4, and dynamically switches the light receiving element 53 to be turned on based on the acquired information. In other words, the control unit 52 may switch the light receiving element 53 to be turned on according to the scanning direction and the scanning speed of the light.

As described above, the control unit 52 according to this embodiment turns on only the light receiving elements 53 that may receive the desired reflected light, and turns off the other light receiving elements 53 in the light receiving array 51. The output signal of the light receiving element 53 in the OFF state is always zero, and there is no possibility that the light receiving element 53 in the OFF state outputs noises. Therefore, the distance measurement unit 42 can measure the distance on the basis of the timing when the light receiving element 53 in the ON state receives light, and can reduce the crosstalk without being affected by the noises of the surrounding pixels. Thus, it is possible to improve the accuracy in distance measurement, and a burden of distance measurement processing can be reduced. In addition, since the number of light receiving elements 53 to be turned on can be reduced, power consumption can be reduced.

### Second Embodiment

In the second embodiment, the number of output wires 54 connected to the plurality of light receiving elements 53 is reduced. As described above, in order to increase the resolution of the distance image, it is necessary to increase the number of light receiving elements 53 per unit area in the light receiving array 51. However, each light receiving element 53 is connected to an output wire 54 for transferring the photoelectrically converted electrical signal. Therefore, if the number of light receiving elements 53 in the light receiving array 51 is increased, it is not possible to secure a region where the output wire 54 is disposed. The second embodiment is provided to solve this problem.

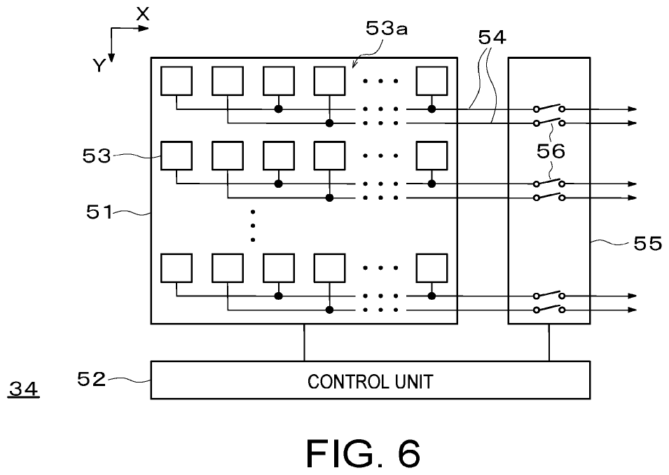

FIG. 6 is a block diagram illustrating an inner configuration of the photo detection apparatus 1 according to the second embodiment. The photo detection apparatus 1 of FIG. 6 includes the light receiving array 51 and the control unit 52 similarly to the light receiving array 51 of FIG. 2, but the number of output wires 54 in photo detection apparatus 1 is small compared to the light receiving array 51 of FIG. 2. A switch array 55 is connected to the output wire 54. Further, the light receiving array 51 of FIG. 2 also requires a switch array, but is omitted in FIG. 2.

The light receiving array 51 of FIG. 6 can significantly reduce the number of output wires 54 compared to the light receiving array 51 of FIG. 2. The light receiving array 51 of FIG. 6 includes the plurality of light receiving elements 53 arranged in a two-dimensional direction, that is, in the second direction X and the third direction Y. More specifically, the light receiving array 51 includes a light receiving element array 53a including m (m is an integer of 2 or more) light receiving elements 53 arranged in at least the second direction X, and n (n is smaller than m, and an integer of 1 or more) output wires 54 which transfers signals received and photoelectrically converted by the m light receiving elements 53. Thus, the number of output wires 54 connected to the m light receiving elements 53 in each light receiving element array 53a is smaller than the total number of light receiving elements 53 in the light receiving element array 53a.

Each of the n light receiving elements 53 arranged adjacent to the second direction X is connected to a different output wire 54. In the case of FIG. 6, two light receiving elements 53 arranged adjacent to each other in the second direction X are connected to different output wires 54, and two output wires 54 are provided with respect to one light receiving element array 53a. That is, the output wire 54 connected to the even-numbered light receiving elements 53 from the left end among the plurality of light receiving elements 53 arranged in the second direction X and the output wire 54 connected to the odd-numbered light receiving elements 53 are separately provided.

In FIG. 6, regardless of the number of light receiving elements 53 in one light receiving element array 53a, the photoelectrically converted electrical signal from each light receiving element 53 is transferred through the two output wires 54. With this configuration, the number of output wires 54 can be significantly reduced. Since the number of output wires 54 can be reduced, the interval between the light receiving element arrays 53a arranged in the third direction Y can be reduced, and the number of light receiving elements 53 per unit area in the light receiving array 51 can be increased.

The switch array 55 includes n switches 56 for selecting any one of the n output wires 54 for each light receiving element array 53a. Similarly to the first embodiment, the control unit 52 according to this embodiment turns on only one or more light receiving elements 53, and turns on the switch 56 linked to the output wire 54 connected to the light receiving elements 53 that are turned on.

In FIG. 6, the light receiving elements 53 in the light receiving element array 53a arranged in the second direction X are alternately connected to the two output wires 54 in an order of arrangement in the second direction X. However, this configuration is because it is assumed that the beam spot diameter of the desired reflected light is equal to the width of the two light receiving elements 53. In this case, since there are two light receiving elements 53 that simultaneously detect light, two adjacent light receiving elements 53 may be turned on, and connected to different output wires 54. Since the other light receiving elements 53 are set in the OFF state, even if they are connected to the same output wire 54 as the output wire 54 of the light receiving element 53 set in the ON state, there is no problem in operation.

The beam spot diameter of the desired reflected light on the light receiving surface of the light receiving array 51 does not depend on the distance from the light receiving array 51 to the object 20 as described in FIG. 4, but depends on the beam spot diameter of the light emitted from the light source in the light projecting unit 3. Therefore, the beam spot diameter can be grasped in advance. Therefore, in this embodiment, the connection between each light receiving element 53 and the output wire 54 is determined in accordance with the beam spot diameter of desired reflected light on the light receiving surface. If the beam spot diameter is the size of two light receiving elements 53, the even-numbered and odd-numbered light receiving elements 53 in the second direction X may be connected to separate output wires 54 as illustrated in FIG. 6.

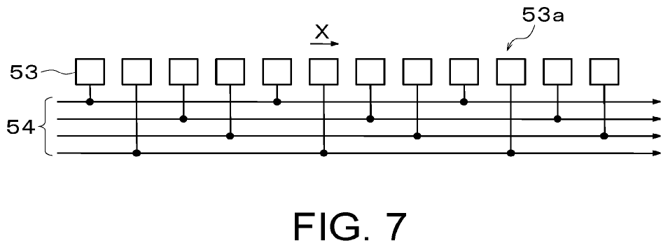

FIG. 7 is a diagram illustrating an example in which every fourth light receiving element 53 among the plurality of light receiving elements 53 arranged in the second direction X is connected to the same output wire 54. In the example of FIG. 7, four output wires 54 are provided for each light receiving element array 53a extending in the second direction X. In FIG. 7, it is assumed that the beam spot diameter of desired reflected light on the light receiving surface of the light receiving array 51 has the size of four light receiving elements 53. In this case, since the four adjacent light receiving elements 53 are simultaneously turned on, these light receiving elements 53 are connected to different output wires 54.

In this way, in the second embodiment, for each light receiving element array 53a, the photoelectrically converted electrical signal from each light receiving element 53 in the light receiving element array 53a is transferred through the output wires 54, the number of which is smaller than the number of light receiving elements 53. Therefore, the total number of output wires 54 can be greatly reduced compared to the number of light receiving elements 53. In addition, in the present embodiment, the connection between each light receiving element 53 and the output wire 54 are connected in accordance with the beam spot diameter of the desired reflected light on the light receiving surface of the light receiving array 51. Therefore, the number of output wires 54 can be reduced within a range that does not hinder the extraction of the light reception signal of the light receiving element 53 in the ON state.

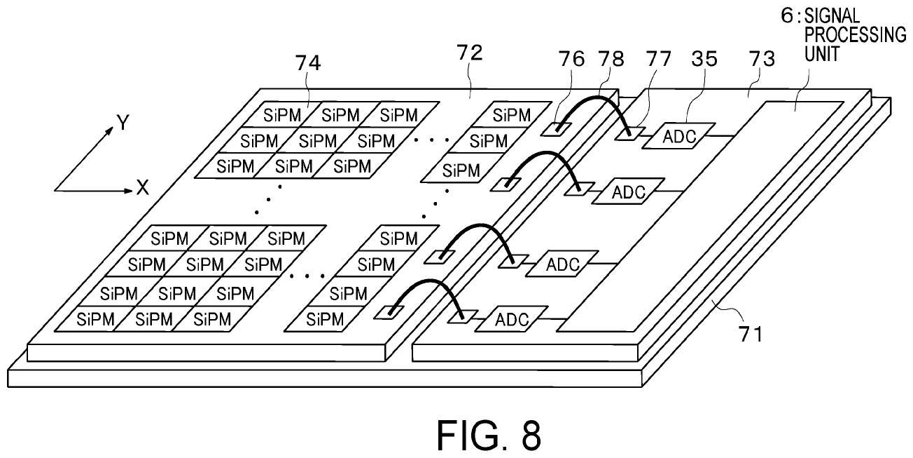

At least a part of the electronic apparatus 2 according to the first and second embodiments can be implemented by a System in Package (SiP). FIG. 8 is a schematic perspective view illustrating an example in which the light receiving unit 5 and the signal processing unit 6 are mounted on a substrate of a package. A first die 72 and a second die 73 are provided on a substrate 71 of FIG. 8. On the first die 72, the light receiving sensor 34 in the light receiving unit 5 of FIG. 1 is disposed. The light receiving sensor 34 is a SiPM 74 which includes the photo detection apparatus 1 of the first to fourth embodiments described above. A plurality of SiPMs 74 are arranged in the X direction and the Y direction. On the second die 73, the A/D converter (ADC) 35 and the signal processing unit 6 in the light receiving unit 5 of FIG. 1 are disposed. A pad 76 on the first die 72 and a pad 77 on the second die 73 are connected by a bonding wire 78.

In the layout diagram of FIG. 8, the plurality of SiPMs 74 are arranged on the first die 72, but an active quench circuit and a passive quench circuit for reducing an APD dead time may be arranged corresponding to each SiPM 74.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A photo detection apparatus, comprising:
an array of light detectors that can be switched to an ON state to enable output of a signal based on reception light or an OFF state to disable output of the signal based on reception light; and
control circuitry configured to:
set one or more first light detectors inside a region specified according to overlapping of a region irradiated with light from a first direction and a region capable of detecting light to the ON state among the array of light detectors, when the light from the first direction is received by the array; and
set second light detectors outside of the specified region to the OFF state among the array of light detectors, when light from a first direction is received by the array.

2. The photo detection apparatus according to claim 1,
wherein the light from the first direction includes a reflected light obtained by reflection of a projected light from an object,
wherein the first direction is a direction of the reflected light.

3. The photo detection apparatus according to claim 2,
wherein the control circuitry is configured to determine the one or more first light detectors set to the ON state based on a receiving position and a beam spot diameter of the reflected light on a surface of the array.

4. The photo detection apparatus according to claim 2,
wherein the first direction is a direction of the reflected light reflected by the object after a predetermined range is scanned by the projected light according to time, and
wherein the control circuitry dynamically controls the one or more light detectors to be turned on among the light detectors according to a direction of the reflected light.

5. The photo detection apparatus according to claim 4,
wherein the control circuitry switches the one or more light detectors to be turned on among the light detectors according to a scanning direction and a scanning speed of light.

6. The photo detection apparatus according to claim 1,
wherein the array includes
an detector array which includes m (m is an integer of 2 or more) light detectors arranged in at least a second direction, and
n (n is smaller than m, and an integer equal to or greater than 1) output wires which transfer electrical signals received and photoelectrically converted by the m light detectors.

7. The photo detection apparatus according to claim 6,
wherein each of the n light detectors arranged adjacent to each other in the second direction is connected to a different output wire.

8. The photo detection apparatus according to claim 7,
wherein the n light detectors connected to the different output wires have a size corresponding to the beam spot diameter of light from the first direction on a light receiving surface of the array.

9. The photo detection apparatus according to claim 7,
wherein the array includes p (p is an integer of 2 or more) detector arrays arranged in a third direction intersecting the second direction, and
wherein the output wires, the number of which is the same as that of the n light detectors, are arranged between the two detector arrays arranged adjacent to each other in the third direction.

10. An electronic apparatus, comprising:
a photo detection apparatus; and
a processor configured to measure a distance to an object based on a time difference between a light projection timing and a light reception timing of the one or more light detectors in the ON state,
wherein the photo detection apparatus comprises:
an array of light detectors that can be switched to an ON state to enable output of a signal based on reception light or an OFF state to disable output of the signal based on reception light; and
control circuitry configured to:
set one or more first light detectors inside a region specified according to overlapping of a region irradiated with light from a first direction and a region capable of detecting light to the ON state among the array of light detectors, when the light from the first direction is received by the array; and
set second light detectors outside of the specified region to the OFF state among the array of light detectors, when light from a first direction is received by the array.

11. The electronic apparatus according to claim 10, further comprising:
a light projector configured to project light,
wherein the control circuitry configured to control such that the one or more light detectors capable of receiving light obtained when the light projected from the light projector is reflected by an object are set to the ON state.

12. The electronic apparatus according to claim 11, further comprising:
a light controller configured to scan in a direction of the light projected from the light projector within a predetermined range.

13. The electronic apparatus according to claim 12,
wherein the control circuitry estimates the predetermined direction on the basis of the scanning direction of the light of the light control circuitry.

14. A photo detection method comprising:
receiving light from a first direction by an array equipped with light detectors; and
among the light detectors that can be switched to an ON state to enable output of a signal based on reception light or an OFF state to disable output of the signal based on reception light,
setting one or more first light detectors inside a region specified according to overlapping of a region irradiated with light from a first direction and a region capable of detecting light to the ON state among the array of light detectors, when the light from the first direction is received by the array; and
setting second light detectors outside of the specified region to the OFF state among the array of light detectors, when light from a first direction is received by the array.

15. The photo detection method according to claim 14,
wherein the light from the first direction includes a reflected light obtained by reflection of a projected light from an object,
wherein the first direction is a direction of the reflected light.

16. The photo detection method according to claim 15,
wherein the setting determines the one or more first light detectors set to the ON state based on a receiving position and a beam spot diameter of the reflected light on a surface of the array.

17. The photo detection method according to claim 15,
wherein the first direction is a direction of the reflected light reflected by the object after a predetermined range is scanned by the projected light according to time, and
wherein the controlling dynamically controls the one or more light detectors to be turned on among the light detectors according to a direction of the reflected light.

18. The photo detection method according to claim 17,
wherein the controlling switches the one or more light detectors to be turned on among the light detectors according to a scanning direction and a scanning speed of light.

19. The photo detection method according to claim 14,
wherein the array includes
an detector array which includes m (m is an integer of 2 or more) light detectors arranged in at least a second direction, and
n (n is smaller than m, and an integer equal to or greater than 1) output wires which transfer electrical signals received and photoelectrically converted by the m light detectors.

20. The photo detection method according to claim 19,
wherein each of the n light detectors arranged adjacent to each other in the second direction is connected to a different output wire.
